(19) United States
(12) Patent Application Publication
(10) Pub. No.: US 2020/0098246 A1
(43) Pub. Date: Mar. 26, 2020

(54) Systems and Methods for Alerting Other Users During An Emergency Situation Faced by a User

(71) Applicant: Michael Stafford, San Carlos, CA (US)

(72) Inventor: Michael Stafford, San Carlos, CA (US)

(21) Appl. No.: 16/575,291

(22) Filed: Sep. 18, 2019

Related U.S. Application Data
(60) Provisional application No. 62/735,859, filed on Sep. 25, 2018.

(51) Int. Cl. G08B 25/00; G08B 5/22; G08B 3/10; H04M 1/725; G08B 25/10

(52) U.S. Cl. CPC G08B 25/006; G08B 5/223; G08B 25/10; H04M 1/72541; G08B 3/1016

(57) ABSTRACT

A system and a method for alerting other users during an emergency situation faced by a user are disclosed. The method includes providing a plurality of Wireless Remote Transmitters (WRTs) connected with a central device, where each WRT is alphanumerically coded. The method further includes receiving, by the central device, an emergency response code from at least one WRT based at least on activation of a WRT by a user. The emergency response code is a unique alphanumeric code of the activated WRT. Further, the method includes modifying, by the central device, the emergency response code to read, display, and transmit any alphanumeric application desired by the user. Thereafter, the method includes sending, by the central device, the emergency response code to an electronic device of at least one other user, to alert the at least one other user of an emergency situation faced by the user.

### CROSS REFERENCE TO RELATED APPLICATION

The present application claims the benefit of U.S. Provisional Application No. 62/735,859 filed Sep. 25, 2018 and is incorporated by reference herein.

### FIELD OF THE DISCLOSURE

The present disclosure is generally related to transmission of a signal, and more particularly related to a method for alerting other users during an emergency situation faced by a user.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Personal security and safety is a high priority to people. As life becomes more urban and complex, the tendency for events that threaten personal safety tends to increase. In order to provide the personal safety, many countries and governments invest in and maintain adequate emergency response capabilities and infrastructure. Also, people rely on private individuals, including family, friends, and insurance companies during emergencies. Typically, mobile phones and other communication devices have made easier for people to contact others during the emergencies.

In one case, a person stuck in an emergency situation would probably try sending a message or calling someone through a mobile phone. Further, the person may shout or scream to gain attention of others during the emergency situation. An alternative to this is usage of wireless transmitters to alert security personnel about the emergency situation faced by the user. The wireless transmitters are known to send a distress signal only to a concerned person without disturbing other persons. Such wireless transmitters are generally fixed at structures, such as buildings and may not be visible to the user, at times. Further, such wireless transmitters are inaccessible to users during the emergency situation. Further, such wireless transmitters have a limited transmission range and could thus transmit distress signals within a limited region only. Furthermore, such wireless transmitters do not provide any acknowledgement for transmission of the distress signals, as their operation is generally silent.

Therefore, there is a need for an improved system for alert transmission that could overcome the above mentioned challenges.

### SUMMARY OF THE INVENTION

According to embodiments illustrated herein, a method for alerting other users during an emergency situation faced by a user is disclosed. The method includes providing a plurality of Wireless Remote Transmitters (WRTs) connected with a central device, where each WRT is alphanumerically coded. The method further includes receiving, by the central device, an emergency response code from at least one WRT based at least on activation of a WRT by a user. The emergency response code is a unique alphanumeric code of the activated WRT. Further, the method includes modifying, by the central device, the emergency response code to read, display, and transmit any alphanumeric application desired by the user. Thereafter, the method includes sending, by the central device, the emergency response code to an electronic device of at least one other user, to alert the at least one other user of an emergency situation faced by the user.

According to embodiments illustrated herein, a system for alerting other users during an emergency situation faced by a user is disclosed. The system includes a plurality of Wireless Remote Transmitters (WRTs), wherein each WRT is alphanumerically coded. The system further includes a central device connected with the plurality of Wireless Remote Transmitters (WRTs). The central device is configured to receive an emergency response code from at least one of WRT based at least on activation of a WRT by a user. The emergency response code is a unique alphanumeric code of the activated WRT. Further, the central device is configured to modify the emergency response code to read, display, and transmit any alphanumeric application desired by the user. Thereafter, the central device is configured to send the emergency response code to an electronic device of at least one other user, to alert the at least one other user of an emergency situation faced by the user.

According to embodiments illustrated herein, a non-transitory computer readable medium stores a computer program code for alerting other users during an emergency situation faced by a user is disclosed. The computer program code is executable by the central device to receive an emergency response code from at least one of WRT based at least on activation of a WRT by a user, the emergency response code is a unique alphanumeric code of the activated WRT, wherein each WRT is connected to the central device. The central device is further configured to modify the emergency response code to read, display, and transmit any alphanumeric application desired by the user. Thereafter, the central device is configured to send the emergency response code to an electronic device of at least one other user, to alert the at least one other user of an emergency situation faced by the user.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a block diagram of a system 100 for alerting other users during an emergency situation faced by a user, according to an embodiment; and

FIG. 2 illustrates a flowchart 200 showing a method of alerting other users during an emergency situation faced by a user, according to an embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

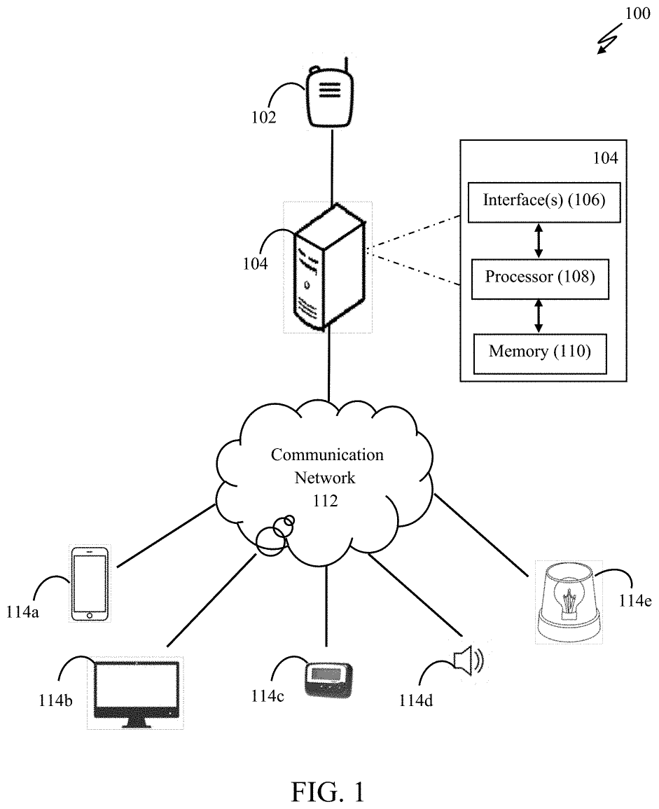

FIG. 1 illustrates a block diagram of a system 100 for alerting other users during an emergency situation faced by a user. The system 100 includes a plurality of Wireless Remote Transmitters (WRTs) 102 connected with a central device 104. Each WRT 102 may be understood as a mini-remote for transmitting a signal to the central device 104. The central device 104 may be a processing equipment, preferably a server or a computer.

The central device 104 may include an interface(s) 106, a processor 108, and a memory 110. The interface(s) 106 may help an operator to interact with the central device 104. The interface(s) 106 may either accept an input from the operator or provide an output to the operator, or may perform both the actions. Further, the interface(s) 106 may either be a Command Line Interface (CLI), Graphical User Interface (GUI), or a voice interface.

The processor 108 includes suitable logic, circuitry, and/or interfaces that are operable to execute one or more instructions stored in the memory 110 to perform predetermined operations. The processor 108 may execute an algorithm stored in the memory 110 for alerting the other users during an emergency situation faced by the user. The processor 108 may also be configured to decode and execute any instructions received from one or more other electronic devices or server(s). The processor 108 may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The processor 108 may be further configured to execute one or more computer-readable program instructions, such as program instructions to carry out any of the functions described in the description provided below.

The memory 110 stores a set of instructions and data. Further, the memory 110 includes the one or more instructions that are executable by the processor 108 to perform specific operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The central device 104 is further connected with a communication network 112 for communicating with electronic devices 114. The electronic devices 114 may include, but are not limited to, a smart phone 114a, a computer 114b, a pager 114c, a sound device 114d, and a light device 114e.

The communication network 112 corresponds to a medium through which content and messages flow between various devices of the system 100 (e.g., the central device 104, and the electronic devices 114). The communication network 112 may be implemented using at least one communication technique selected from Visible Light Communication (VLC), Worldwide Interoperability for Microwave Access (WiMAX), Long term evolution (LTE), Wireless local area network (WLAN), Infrared (IR) communication, Public Switched Telephone Network (PSTN), Radio waves, and any other wired and/or wireless communication technique known in the art.

In one embodiment, the user may carry the WRT 102 in a pocket. Alternatively, the WRT 102 may be installed in a wrist band worn by the user, a lanyard worn around the neck, or the lanyard may be installed on user's cloth or body using an adhesive strip or Velcro. The WRT 102 may also be attached to an equipment, a wall or any structure within a building. Further, the WRT 102 may be tethered with the central device 104. In one case, the WRT 102 may be tethered with the central device 104 while present within a range of 500 feet. Each WRT 102 may be alphanumerically coded at the point of manufacturing. It should be noted that each WRT 102 may be hard coded or paired in the memory 110 of the central device 104 to identify each WRT 102 as a unique alert device.

In one embodiment, the central device 104 may send a test signal to each WRT 102 for verifying connectivity and a state of battery charge of each WRT 102. The test signal could be sent periodically, at predefined time intervals. At first, the user may activate the WRT 102 whenever threatened or in a problematic situation. In one case, the WRT 102 may be activated by pressing a button present on the WRT 102. Alternatively, the WRT 102 may be activated by other means such as by tapping or shaking to enable a particular sensor responsible for activating the WRT 102. In one case, the sensor may be an accelerometer. Further, the WRT 102 may include a small Light Emitting Device (LED) for indicating the user about the activation of the WRT 102.

Upon activation, the WRT 102 may send an emergency response code to the central device 104. The emergency response code may be sent directly to the central device 104 or may be transmitted to a wireless router or signal booster configured to forward the emergency response code to the central device 104. The emergency response code may be a unique alphanumeric code associated with the WRT 102. Further, the unique alphanumeric code may be stored in a memory of the WRT 102. In one case, the alphanumeric code may comprise 10 digits. In another case, 99 unique alphanumeric codes may be assigned to different WRTs 102 to distinctly identify each WRT 102 when activated during the emergency situation. In one embodiment, the central device 104 may send a firmware update to the WRT 102, for updating the alphanumeric code, when required.

Post receiving the emergency response code, the central device 104 may modify the emergency response code to read, display, and transmit any alphanumeric application desired by the user. Thereafter, the central device 104 may send the emergency response code to at least one electronic device of the electronic devices 114 operated by other users. In one embodiment, the electronic devices 114 may be a smart phone 114a, a computer 114b, a pager 114c, a sound device 114d, and a light device 114e. In one case, the emergency response code may be displayed on the smart phone 114a, the computer 114b, and/or the pager 114c, alerting the other users owning or operating the smart phone 114a, the computer 114b, and/or the pager 114c about an emergency situation faced by the user. As the emergency response code is unique for each WRT 102, the other users receiving such unique code would be able to identify the user facing the emergency situation and could act promptly. In another case, the sound device 114d and/or the light device 114e may switch ON to alert the other users.

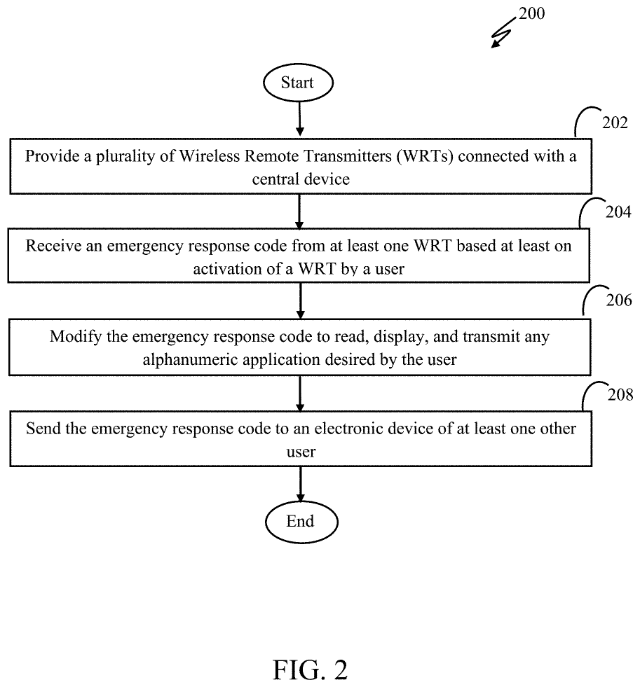

FIG. 2 illustrates a flowchart 200 showing a method alerting other users during an emergency situation faced by a user, according to an embodiment. FIG. 2 comprises a flowchart 200 that is explained in conjunction with the elements disclosed in FIG. 1.

The flowchart 200 of FIG. 2 shows the architecture, functionality, and operation for alerting other users during an emergency situation faced by a user. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 2 may be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 200 starts at the step 202 and proceeds to step 208.

At step 202, a plurality of Wireless Remote Transmitters (WRTs) 102, connected with a central device 104, may be provided to a user, in accordance with an embodiment.

At step 204, the central device 104 may receive an emergency response code from at least one WRT 102, based at least on an activation of the WRT 102 by a user. In one case, the emergency response code may be received while the user activates the WRT 102 in an emergency situation. The emergency response code may be a unique alphanumeric code stored in a memory of the WRT 102, in accordance with an embodiment.

At step 206, the central device 104 may modify the emergency response code to read, display, and transmit any alphanumeric application desired by the user of the WRT 102, in accordance with an embodiment.

At step 208, the central device 104 may send the emergency response code to at least one electronic device of electronic devices 114 belonging to other users, for alerting the other users during an emergency situation. The electronic devices 114 may include a smart phone 114a, a computer 114b, a pager 114c, a sound device 114d, and a light device 114e, in accordance with an embodiment.

The disclosed embodiments encompass numerous advantages. Various embodiments of method and device for alerting other users during an emergency situation faced by a user have been disclosed. Such method provides a plurality of Wireless Remote Transmitters (WRTs) connected with a central device, where each WRT is alphanumerically coded. The central device receives an emergency response code from at least one WRT based at least on activation of a WRT by a user. The emergency response code is a unique alphanumeric code of the activated WRT. Further, the central device modifies the emergency response code to read, display, and transmit any alphanumeric application desired by the user. Thereafter, the emergency response code is sent to an electronic device of at least one other user, to alert at least one other user of an emergency situation faced by the user. Such method and system provides better transmission range, acknowledgement for transmission of distress signals, and a better alert transmission that eliminates shouting or screaming of a person during an emergency situation.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A method for alerting other users during an emergency situation faced by a user, the method comprising:
providing a plurality of Wireless Remote Transmitters (WRTs) connected with a central device, wherein each WRT is alphanumerically coded;
receiving, by the central device, an emergency response code from at least one WRT based at least on activation of a WRT by a user, wherein the emergency response code is a unique alphanumeric code of the activated WRT;
modifying, by the central device, the emergency response code to read, display, and transmit any alphanumeric application desired by the user; and
sending, by the central device, the emergency response code to an electronic device of at least one other user, to alert the at least one other user of an emergency situation faced by the user.

2. The method of claim 1, wherein the electronic device is one of a pager, a smart phone, a computer, a light device, and a sound device.

3. The method of claim 1, further comprising sending, by the central device, a signal to verify connectivity and a state of battery charge of each WRT.

4. The method of claim 1, wherein each WRT is installed using an adhesive strip or Velcro.

5. The method of claim 1 further comprising sending, by the central device, a firmware update to each WRT for updating the unique alphanumeric code.

6. The method of claim 1, wherein each WRT is activated by pressing a button on the WRT, by tapping or shaking to enable a sensor for activating the WRT.

7. The method of claim 1, wherein the emergency response code associated with the plurality of Wireless Remote Transmitters (WRTs) is stored in a memory of the central device to identify each WRT as a unique alert device.

8. A system for alerting other users during an emergency situation faced by a user, the system comprising:
a plurality of Wireless Remote Transmitters (WRTs), wherein each WRT is alphanumerically coded; and
a central device connected with the plurality of Wireless Remote Transmitters (WRTs), the central device is configured to:
receive an emergency response code from at least one of WRT based at least on activation of a WRT by a user, wherein the emergency response code is a unique alphanumeric code of the activated WRT;
modify the emergency response code to read, display, and transmit any alphanumeric application desired by the user; and
send the emergency response code to an electronic device of at least one other user, to alert the at least one other user of an emergency situation faced by the user.

9. The system of claim 8, wherein the electronic device is at least one of a pager, a smart phone, a computer, a light device, and a sound device.

10. The system of claim 8, wherein the central device is configured to send a signal to verify connectivity and a state of battery charge of each WRT.

11. The system of claim 8, wherein each WRT is installed using an adhesive strip or Velcro.

12. The system of claim 8, wherein the central device is configured to send a firmware update to each WRT for updating the unique alphanumeric code.

13. The system of claim 8, wherein each WRT is activated by pressing a button on the WRT, by tapping or shaking to enable a sensor for activating the WRT.

14. The system of claim 8, wherein the emergency response code associated with the plurality of Wireless Remote Transmitters (WRTs) is stored in a memory of the central device to identify each WRT as a unique alert device.

15. A non-transitory computer-readable medium for storing instructions, wherein the instructions are executed by a central device, wherein the central device is configured to:
receive an emergency response code from at least one of WRT based at least on activation of a WRT by a user, the emergency response code is a unique alphanumeric code of the activated WRT, wherein each WRT is connected to the central device;
modify the emergency response code to read, display, and transmit any alphanumeric application desired by the user; and
send the emergency response code to an electronic device of at least one other user, to alert the at least one other user of an emergency situation faced by the user.

16. The non-transitory computer-readable medium according to claim 15, wherein each WRT is alphanumerically coded and installed using an adhesive strip or Velcro

17. The non-transitory computer-readable medium according to claim 15, wherein the electronic device is at least one of a pager, a smart phone, a computer, a light device, and a sound device.

18. The non-transitory computer-readable medium according to claim 15, wherein the central device is configured to send a signal to verify connectivity and a state of battery charge of each WRT.

19. The non-transitory computer-readable medium according to claim 15, wherein the central device is configured to send a firmware update to each WRT for updating the unique alphanumeric code.

20. The non-transitory computer-readable medium according to claim 15, wherein each WRT is activated by pressing a button on the WRT, by tapping or shaking to enable a sensor for activating the WRT.
